(19) United States
(12) Patent Application Publication
(10) Pub. No.: US 2006/0123240 A1
(43) Pub. Date: Jun. 8, 2006

(54) Secure biometric authentication system and method of implementation thereof

(76) Inventor: Alison Chaiken, Fremont, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/008,337

(22) Filed: Dec. 8, 2004

(51) Int. Cl. H04K 1/00; H04L 9/00; G06F 9/24; G06F 15/177; G06F 9/445; G06F 9/00

(52) U.S. Cl. 713/186; 713/2

(57) ABSTRACT

A biometrically authenticatable system is disclosed. The system includes a Basic Input Output System (BIOS), an operating system and a biometric authentication mechanism logically coupled in-between the BIOS and the operating system.

### FIELD OF THE INVENTION

The present invention relates generally to the field of device security and more particularly to a method and system for authenticating a user of a device.

### BACKGROUND OF THE INVENTION

There are many processes for authenticating of a user to verify the identity of the user or the user's eligibility to access particular resources in a stand-alone computer system or portable electronic device. Different system administrators may have different security requirements according to the business needs of the systems they administer and they may require different types of authentication mechanisms. For example, some systems only require presenting a simple user id and password. Other systems are sophisticated and require the user to employ authentication mechanisms such as a smart card, a token card, or a fingerprint scanner.

Biometric authentication is potentially the most robust and convenient method of user authentication for portable and desktop/enterprise computer systems. It doesn't require the user to invent or remember passwords or to carry a badge or a smart card. Biometric authentication processes include finger print scanning, graphical signature scanning, dynamic hand-force sensing while executing a signature, iris and retinal scanning, voice print scanning, and many other techniques. Fingerprint scanning is currently the most proven form of biometric authentication. Other developing biometric authentication processes include retina and iris scanning, hand and face geometry scanning, body odor profiling, and vein scanning.

Computerized iris recognition converts the image of an eye into a sequence of numbers by component analysis and three-dimensional imaging technology. The iris is rich in features such as fibers, striations, freckles, rifts, pits and other details which contribute to an identity that is more complex than a fingerprint. Body odor profiling recognizes the chemicals that make up a person's individual smell, and separates them to build up a template. Behavioral biometrics measure how a person performs a task. The two most advanced behavioral biometric authentication processes are signature and voice recognition. Signature recognition authentication is used in credit card and other banking applications. Voice recognition or voice print authentication processes work by isolating characteristics that produce speech, rather than by recognizing the tone of the voice itself.

FIG. 1 is an illustration of a conventional biometric system 100 for authenticating a device. The conventional system 100 includes a basic input output system (BIOS) 110, boot elements 120, an operating system 130, a biometric authentication mechanism 140 and a plurality of user programs 150. The BIOS 110 is coupled to the boot elements 120. The boot elements 120 include a master boot record on disk-zero 121 and boot sector code on an active partition 122. The boot elements 120 is coupled to the operating system 130 wherein the operating system 130 is coupled to the biometric authentication mechanism 140. The biometric authentication mechanism 140 is coupled to the user programs 150. Accordingly, a user initiates the BIOS 110 and accesses the operating system 120 via boot elements 120 at which point the biometric authentication mechanism 140 is initiated.

Although the above-described methods of biometric authentication are effective, these methods are only effective in protecting data (i.e. software files) that are contained within the associated devices. These methods do nothing to protect the actual hardware. They do not prevent the theft and resale of the device, only the misuse of confidential data contained therein. For example, if a device was stolen after an employee had logged in (e.g. if the employee goes to the bathroom), the data would still be vulnerable.

Accordingly, what is needed is a method and system that addresses the problems related to the physical security of devices in addition to the safety of data. The method and system should be simple, cost effective and capable of being easily adapted to existing technology.

### SUMMARY OF THE INVENTION

A secure biometric system is disclosed. The system includes a Basic Input Output-System (BIOS), an operating system and a biometric authentication mechanism logically coupled in-between the BIOS and the operating system.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a block diagram of a conventional biometric authentication system.

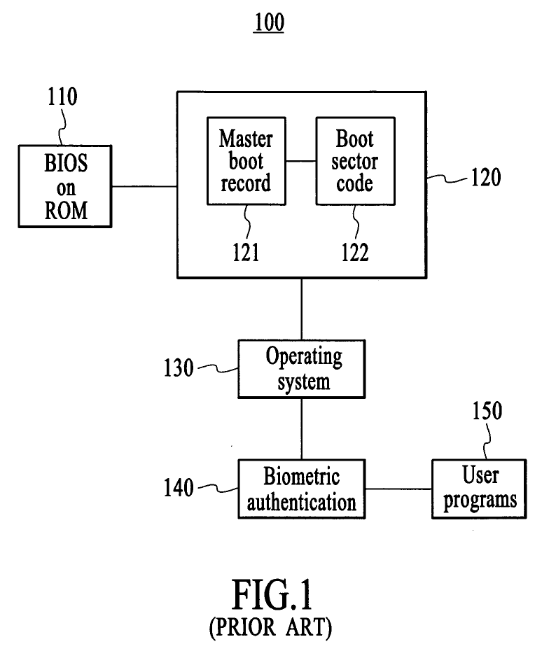

FIG. 2 is a flowchart of a method in accordance with an embodiment of the present invention.

FIG. 3 is a block diagram of a system in accordance with an embodiment of the present invention.

FIG. 4 shows an illustration of iris based authentication mechanism in accordance with an embodiment of the present invention.

FIG. 5 shows an illustration of fingerprint based authentication mechanism in accordance with an embodiment of the present invention.

FIG. 6 is a block diagram of a computer system that could by utilized in conjunction with the present invention.

FIG. 7 is a block diagram of a cellular telephone that could by utilized in conjunction with the present invention.

FIG. 8 is a flowchart of program instructions that could be contained within a computer readable medium in accordance with the alternate embodiment of the present invention.

### DETAILED DESCRIPTION

The present invention relates to a secure biometric authentication system and method of implementation thereof. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

As shown in the drawings for purposes of illustration, varying embodiments of a secure biometric authentication system and method of implementation thereof are disclosed. Accordingly, a biometric authentication mechanism is implemented in conjunction with a basic input output system (BIOS) of a device wherein the biometric authentication mechanism is logically coupled in-between the BIOS and an operating system logically contained within the device. By logically coupling the biometric authentication mechanism in-between the BIOS and an operating system, a user cannot access the device operating system without proper biometric authentication. Consequently, the device hardware is protected in addition to the data contained within the hardware.

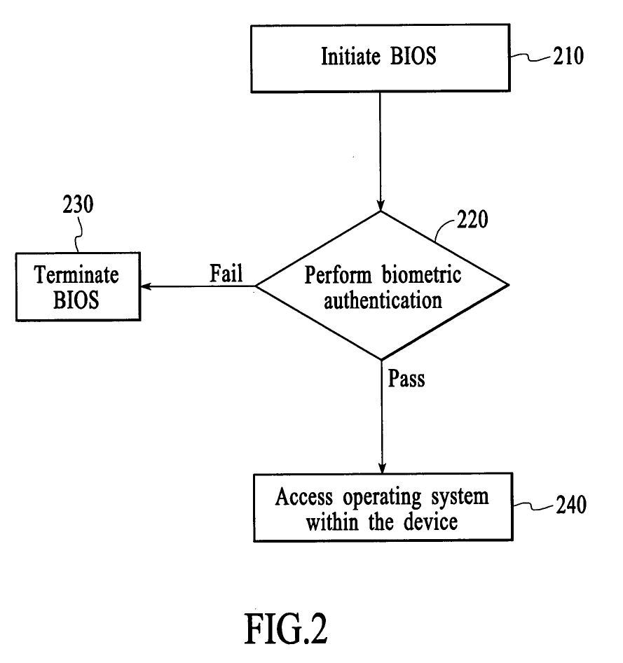

FIG. 2 is a flowchart of a method of authenticating a device. A first step 210 includes initiating a BIOS within the device. The next step 220 includes performing a biometric authentication process. In varying embodiments, the biometric authentication process includes an iris based authentication process or a fingerprint based authentication based process. If a user fails the biometric authentication process, BIOS sequence is terminated via step 230. If a user passes the biometric authentication process, the final step 240 includes accessing an operating system within the device.

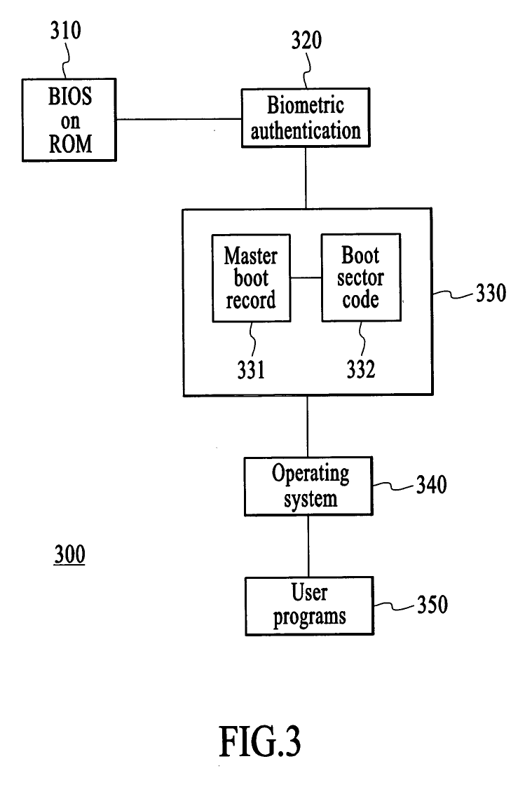

FIG. 3 shows an example of a biometric authentication system 300 in accordance with an embodiment. The system 300 includes a BIOS 310, a biometric authentication mechanism 320, boot elements 330, an operating system 340 and a plurality of user programs. As can be seen in FIG. 3, the biometric authentication mechanism 310 is logically coupled in-between the BIOS 310 and the operating system 340. What is meant by the phrase “logically coupling the biometric authentication mechanism 320 in between the BIOS 310 and the operating system 340” is that the biometric authentication mechanism 320 is implemented after the initiation of the BIOS 310 and before the operating system 340 can be accessed. Consequently, a user cannot access the device operating system without proper biometric authentication.

The BIOS is a set of routines which are stored on a chip and provide an interface between the operating system and the hardware. The BIOS supports all peripheral technologies and internal services such as the realtime clock (time and date). On startup, the BIOS tests the system and prepares the device for operation by querying its own small CMOS memory bank for drive and other configuration settings. It searches for other BIOS's on the plug-in boards and sets up pointers (interrupt vectors) in memory to access those routines. It then loads the operating system and passes control to it. The BIOS accepts requests from the drivers as well as the application programs. BIOSs must periodically be updated to keep pace with new peripheral technologies. If the BIOS is stored on a read-only memory chip (ROM BIOS), then a thief would have to replace the chip if he/she wanted to circumvent the biometric authentication system. Consequently, replacing a surface mount ROM chip is beyond the capability of most thieves.

An operating system is the master control program that runs the computer/device. The first program loaded when the computer is turned on, its main part, the “kernel,” resides in memory at all times. The operating system sets the standards for all application programs that run in the computer/device. The applications “talk to” the operating system for all user interface and file management operations. Also called an “executive” or “supervisor,” an operating system performs task management, data management, job management, device management and the like. Windows and Unix are two exemplary operating systems that are in use in many devices.

In an embodiment, biometric authentication mechanism 320 is a miniaturized iris-based authentication mechanism. Accordingly, through the use of micro-electromechanical system (MEMS) technology, infrared sources and Si photodetectors, a small iris-based authentication mechanism is installed on the motherboard of a laptop or handheld PDA device. When the unit is purchased, the single user of the system burns his/her biometric data into a surface-mount write-once programmable read-only memory (PROM) on the motherboard.

As previously outlined, the biometric mechanism is logically coupled in between the BIOS and the operating system. As a result, when the device is booted, a biometric authentication process is implemented after the initiation of the BIOS and prior to accessing the operating system. Consequently, if the authentication process is successful the operating system is accessed. However, if the authentication process is unsuccessful, the device immediately shuts down. Such rigorous security should be acceptable to potential customers because biometric identifiers cannot be lost or forgotten. Since eyes are rarely injured and iris patterns are stable over a lifetime, iris-based biometric authentication is more secure and convenient to device users.

If the biometric authentication is integrated within the system firmware in this way, a potential thief cannot easily compromise the security system by writing new data to the disk drive or other storage unit. While this incorporation of biometric authentication into the firmware of the device does not mean that the device cannot be stolen, it could make the theft of the device extremely unattractive. In particular, any security feature that costs more to defeat than the purchase of a new unit, significantly reduces the likelihood that the unit will be stolen.

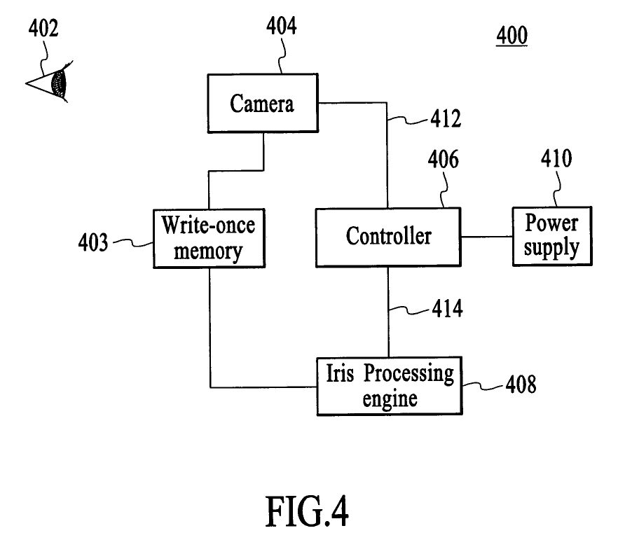

FIG. 4 shows an example of an iris-based authentication mechanism 400 that could be utilized in conjunction with the present embodiment. The mechanism 400 includes a camera 404, a controller 406, an iris-processing engine 408. The camera 404 is coupled to the controller 406 and the controller 406 is coupled to the iris-processing engine 408. The mechanism 400 is energized by a suitable power supply 410 through controller 406 which is connected to camera 404 and iris-processing engine 408, respectively, through leads 412, 414.

When the device is first purchased and turned on, BIOS is initiated and the camera 404 captures an image of the user's eye and stores it in a write-once programmable memory 403. During any subsequent operation, after the initiation of the BIOS sequences, the camera 404 captures an image of a user's eye 402. The camera 404 then sends this image to the iris-processing engine 408 via the controller 406. The iris-processing engine 408 then checks the image against the image previously stored in the write once programmable memory 403. If the authentication process is successful the associated operating system is accessed. However, if the authentication process is unsuccessful, the associated device immediately shuts down.

Although the above-described embodiment is shown with a single camera, one of ordinary skill in the art will readily recognize that multiple cameras can be implemented.

Iris identification has numerous advantages over other biometric identification processes including the fact that iris identification is intrinsically more accurate due to the greater differences among human irises as compared to other biometric identifiers. One of the distinct advantages of the iris identification for the proposed application is that potentially it does not require the cooperation of the user. For example, in an embodiment that incorporates three video cameras, an unauthorized user can be detected quickly and appropriate security actions can be taken by the system/device.

In an alternate embodiment, the system can be configured to operate in an attention-based mode. In the attention-based mode, the system is configured whereby the screen of the device/computer goes blank when the eye(s) of the authorized user are not visible. This type of enhanced security system would be attractive to potential enterprise customers not only for portable devices but for desktop systems as well. An attention-based mode could also save power in portable electronics. This is advantageous since most portable devices operate with a re-chargeble battery wherein the duration of operation time is based on the power consumption of the device. Furthermore, a parent could restrict access to certain files or certain web-sites to the adults in the family based iris identification.

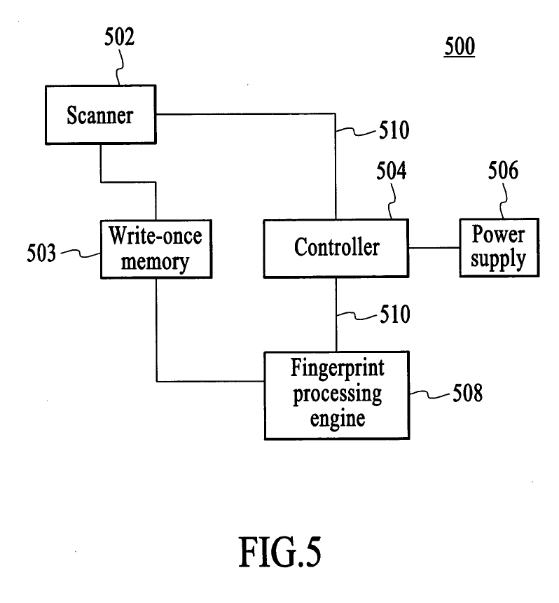

In an alternate embodiment, a fingerprint based authentication mechanism is implemented. FIG. 5 shows a finger print based authentication mechanism 500 in conjunction with an embodiment. The system 500 includes a fingerprint scanner 502, a controller 504, a power supply 506 and a fingerprint-processing engine 508. The mechanism 500 is energized by a suitable power supply 506 through controller 504, which is connected to scanner 502, and fingerprint-processing engine 508, respectively, through leads 510, 512.

Accordingly, when the associated device is first purchased and turned on, BIOS is initiated and the fingerprint scanner 502 is utilized to captures an image of the user's fingerprint which is stored in a write-once programmable memory 503. During any subsequent operation, the scanner 502 captures an image of a user's fingerprint. The scanner 502 then sends this image to the fingerprint-processing engine 508 via the controller 504. The fingerprint-processing engine 508 then checks the image against the image previously stored in the write-once memory 503. If the authentication process is successful the associated operating system is accessed. However, if the authentication process is unsuccessful, the associated device immediately shuts down.

Additionally, an attention-based mode could be implemented with the scanner 502 whereby the display of the associated device is blanked when the unique user's fingers are removed from the keys.

Although the above-described embodiments disclose the implementation of iris and fingerprint based authentication, one of ordinary skill in the art will readily recognize that any biometric identifier could be utilized in conjunction with the above-described embodiments.

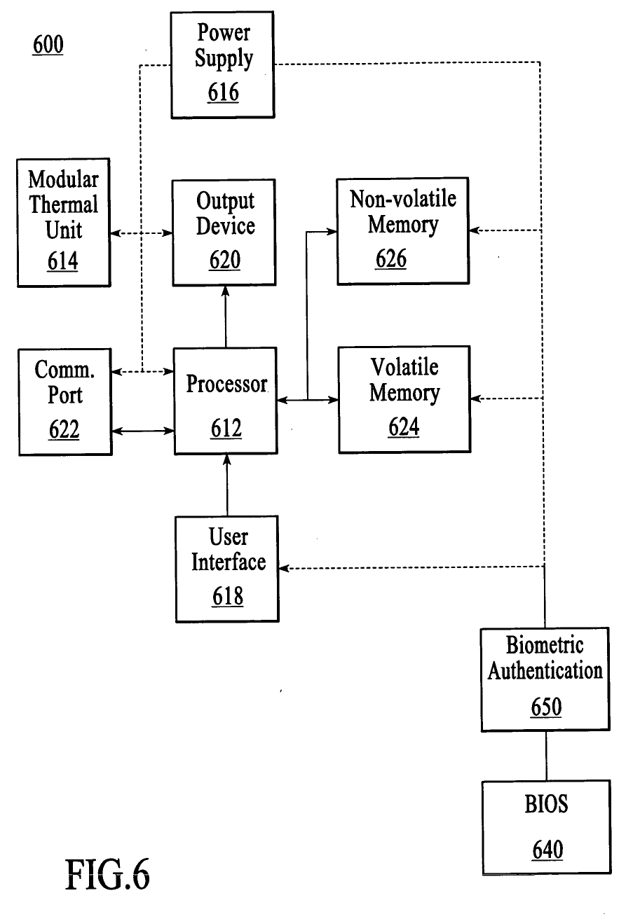

In an embodiment, the method is implemented in conjunction with a portable device such as a laptop computer. FIG. 6 is a block diagram of a laptop computer 600 that could be utilized in conjunction with an embodiment. In the illustrated embodiment, a processor 612 controls the functions of computer system 600. In this embodiment, data, as illustrated by the solid line, is transferred between the processor 612 and the components of system 600. Additionally, a modular thermal unit 614 is used to remove heat from the processor 612. Computer 600 also includes a power supply 616 to supply electrical power, as illustrated by the dashed line, to the components of computer system 600. Additionally, power supply 616 may include a battery.

Computer system 600 may incorporate various other components depending upon the desired functions of computer 600. In the illustrated embodiment, a user interface 618 is coupled to processor 612. Examples of a user interface 618 include a keyboard, a mouse, and/or a voice recognition system. Additionally, an output device 620 is coupled to processor 612 to provide a user with visual information. Examples of an output device 620 include a computer monitor, a television screen, a printer or the like. In this embodiment a communications port 622 is coupled to processor 612 to enable the computer system 600 to communicate with an external device or system, such as a printer, another computer, or a network.

Processor 612 utilizes software programs to control the operation of computer 600. Electronic memory is coupled to processor 612 to store and facilitate execution of the programs. In the illustrated embodiment, processor 612 is coupled to a volatile memory 624 and a non-volatile memory 626. A variety of memory types, such as DRAMs, SDRAMs, SRAMs, etc., may be utilized as volatile memory 624. Non-volatile memory 626 may include a hard drive, an optical storage, or another type of disk or tape drive memory. Non-volatile memory 626 may also include a read only memory (ROM), such as an EPROM, to be used in conjunction with volatile memory 624.

In accordance with varying embodiments, the system 600 also includes a BIOS 640 which is coupled to a biometric authentication mechanism 650 wherein the biometric authentication mechanism 650 controls the access to an operating system within the non-volatile memory 626. Accordingly, the biometric authentication mechanism 650 accesses a write-once memory within the non-volatile memory 650 to perform the biometric authentication.

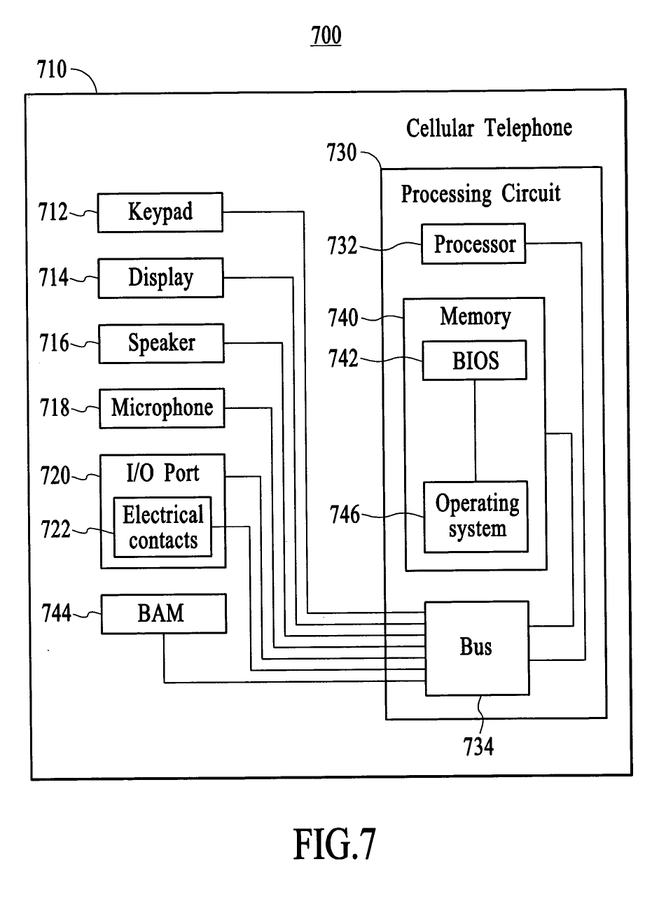

In an alternate embodiment, the method is implemented in conjunction with a cellular telephone. FIG. 7 is a block diagram of a cellular telephone 700 that could be utilized in conjunction with an alternate embodiment. The cellular telephone 700 includes a keypad 712, a display 714, a speaker 716, a microphone 718, an input/output (I/O) port 720 and a processing circuit 730. The processing circuit 730 includes a processor 732, a bus 734, and a memory 740. The bus 734 is used to interconnect the various electronic components of the cellular telephone 700. Hence, the keypad 712, display 714, speaker 716, microphone 718, and input/output (I/O) port 720 are electrically connected to the processing circuit 730 via the bus 734.

Similarly, the memory 740 and processor 732 are electrically connected to the bus 734. The processing circuit 730 controls the operations of the cellular telephone 700. Specifically, by using the bus 734, the processor 732 is able to connect to and control the other electronic elements of the cellular telephone 700.

The memory 740 holds memory and data that are required for the operations of the processor 732. In particular, the memory 740 includes a BIOS 742 and an operating system 746. Coupled in between the BIOS 742 and the operating system 746 is a biometric authentication mechanism 744. Accordingly, when the cellular telephone 700 is powered on, the biometric authentication mechanism 744 is implemented after the BIOS 742 in order to authenticate the user prior to initiating the operating system 746.

Although the above-described embodiments are disclosed in conjunction with a laptop computer and a cellular telephone, a variety of different devices such as a desktop computer, a personal digital assistant, etc. could be utilized.

The above-described method may also be implemented, for example, by operating a computer system/device to execute a sequence of machine-readable instructions. The instructions may reside in various types of computer readable media. In this respect, another aspect of the present invention concerns a programmed product, including computer readable media tangibly embodying a program of machine-readable instructions executable by a digital data processor to perform the method in accordance with an embodiment of the present invention.

This computer readable media may include, for example, RAM (not shown) contained within the system. Alternatively, the instructions may be contained in another computer readable media such as a magnetic data storage diskette and directly or indirectly accessed by the computer system. Whether contained in the computer system or elsewhere, the instructions may be stored on a variety of machine readable storage media, such as a DASD storage (e.g. a conventional “hard drive” or a RAID array), magnetic tape, electronic read-only memory, an optical storage device (e.g., CD ROM, WORM, DVD, digital optical tape), or other suitable computer readable media including transmission media such as digital, analog, and wireless communication links. In an illustrative embodiment of the invention, the machine-readable instructions may include lines of compiled C, C++, or similar language code commonly used by those skilled in the programming for this type of application arts.

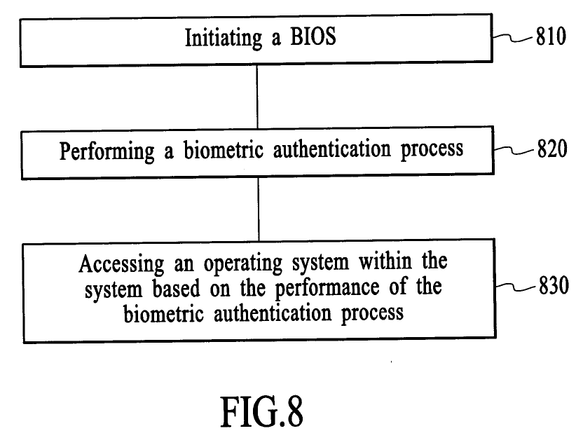

FIG. 8 is a flowchart of program instructions that could be contained within a computer readable medium in accordance with the alternate embodiment. A first step 810 involves initiating a BIOS. A second step 820 involves performing a biometric authentication process by comparing user data against parameters stored on a write-once PROM. A final step 830 involves accessing an operating system within the system based on the performance of the biometric authentication process. Accordingly, if the biometric authentication process does not properly authenticate the system user, access to the operating system will be denied.

As shown in the drawings for purposes of illustration, varying embodiments of a biometrically authenticatable system and method of implementation thereof are disclosed. Accordingly, a biometric mechanism is implemented in conjunction with a basic input output system (BIOS) of a device wherein the biometric authentication mechanism is logically coupled in-between the BIOS and an operating system logically contained within the device. By logically coupling the biometric authentication mechanism in-between the BIOS and an operating system, a user cannot access the device operating system without proper biometric authentication. Consequently, the device hardware is protected in addition to the data contained within the hardware.

Without further analysis, the foregoing so fully reveals the gist of the present invention that others can, by applying current knowledge, readily adapt it for various applications without omitting features that, from the standpoint of prior art, fairly constitute essential characteristics of the generic or specific aspects of this invention. Therefore, such applications should and are intended to be comprehended within the meaning and range of equivalents of the following claims. Although this invention has been described in terms of certain embodiments, other embodiments that are apparent to those of ordinary skill in the art are also within the scope of this invention, as defined in the claims that follow.

What is claimed:

1. A secure biometric authentication system comprising:
a Basic Input Output System (BIOS);
an operating system; and
a biometric authentication mechanism logically coupled in-between the BIOS and the operating system.

2. The system of claim 1 further comprising a write-once memory component wherein the write-once memory component includes biometric data.

3. The system of claim 1 wherein the biometric authentication mechanism comprises and iris authentication mechanism.

4. The system of claim 1 wherein the biometric authentication mechanism comprises a fingerprint type authentication mechanism.

5. The system of claim 1 wherein the system comprises a laptop computer.

6. The system of claim 1 wherein the system comprises a personal digital assistant.

7. The system of claim 1 wherein the system comprises a cellular telephone.

8. The system of claim 3 wherein the iris authentication mechanism is attention based.

9. A method of biometrically authenticating a system comprising:
initiating a BIOS;
performing a biometric authentication process; and
accessing an operating system within the system based on the performance of the biometric authentication process.

10. The method of claim 9 wherein performing a biometric authentication process further comprises:
implementing an iris based authentication process.

11. The method of claim 9 wherein performing a biometric authentication process further comprises:
implementing a fingerprint based authentication process.

12. The method of claim 9 wherein performing a biometric authentication process further comprises:
accessing a write-once memory component to retrieve biometric data.

13. The method of claim 9 wherein the system comprises a laptop computer.

14. The method of claim 9 wherein the system comprises a personal digital assistant.

15. The method of claim 9 wherein the system comprises a cellular telephone.

16. The method of claim 10 wherein the iris based authentication process is attention based.

17. A computer program product for authenticating a system, the computer program product comprising a computer usable medium having computer readable program means for causing a computer to perform the steps of:
initiating a BIOS;
performing a biometric authentication process; and
accessing an operating system within the system based on the performance of the biometric authentication process.

18. The computer program product of claim 17 wherein performing a biometric authentication process further comprises:
implementing an iris based authentication process.

19. The computer program product of claim 17 wherein performing a biometric authentication process further comprises:
implementing an fingerprint based authentication process.

20. The computer program product of claim 17 wherein performing a biometric authentication process further comprises:
accessing a write-once memory component to retrieve biometric data.

21. The computer program product of claim 17 wherein the system comprises a laptop computer.

22. The computer program product of claim 17 wherein the system comprises a personal digital assistant.

23. The computer program product of claim 17 wherein the system comprises a cellular telephone.

24. The computer program product of claim 18 wherein iris based authentication process is attention based.

25. A secure biometric authentication system comprising:
a Basic Input Output System (BIOS);
an operating system;
a biometric authentication mechanism logically coupled in-between the BIOS and the operating system; and
means for storing biometric information coupled to the biometric authentication mechanism.

26. The system of claim 25 wherein the means for storing biometric information comprises a write-once programmable memory.

27. The system of claim 25 wherein logically coupling the biometric authentication mechanism in-between the BIOS and the operating system means that the biometric authentication mechanism is implemented after the initiation of the BIOS and before the operating system can be accessed.

28. The method of claim 25 wherein the biometric information further comprises information related to an iris.

29. The method of claim 25 wherein the biometric information further comprises information related to a fingerprint.
